(19) United States
(12) Patent Application Publication
(10) Pub. No.: US 2007/0258425 A1
(43) Pub. Date: Nov. 8, 2007

(54) Method of assigning address in wireless personal area network

(75) Inventors: Eun-il Seo, Yongin-si (KR); Jin-young Yang, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/651,059

(22) Filed: Jan. 9, 2007

(30) Foreign Application Priority Data
May 3, 2006 (KR) 10-2006-0040045

(51) Int. Cl. H04Q 7/24

(52) U.S. Cl. 370/338

(57) ABSTRACT

A method of allocating an address to a mobile node constituting a wireless network in a tree structure. A mobile node receives a wireless network identification (ID) and sets an address of the mobile node, based on the wireless network ID. Accordingly, an address is set based on a PAN ID which is a randomly set variable According to the method, addresses of mobile nodes can avoid conflict in a comparatively simple manner.

### CROSS-REFERENCE TO RELATED APPLICATIONS

This application claims priority from Korean Patent Application No. 10-2006-0040045, filed on May 3, 2006, in the Korean Intellectual Property Office, the disclosure of which is incorporated herein by reference.

### BACKGROUND OF THE INVENTION

1. Field of the Invention

Methods consistent with the present invention relate to a wireless personal area network (WPAN). More particularly, the present invention relates to a method of assigning addresses to mobile nodes constituting the WPAN.

2. Description of the Related Art

The WPAN consists of a plurality of mobile nodes, which are connected to each other in a tree structure. Each of the mobile nodes is assigned an address. FIG. 1 shows mobile nodes, which are each assigned addresses, constituting the WPAN, in a tree structure.

The mobile nodes are assigned addresses in the respective WPANs. Accordingly, two mobile nodes of two different WPANs may be assigned the same address. When two mobile nodes of two different WPANs are assigned the same address, address conflict may occur. In addition, if the two different WPANs have the same personal area network identification (PAN ID), then PAN ID conflict also occurs.

Although address conflict occurs, if the PAN IDs of the WPANs of the two mobile nodes are different, communication is still possible based on the PAN IDs. However, a packet needs an additional field for the PAN ID, and this means that protocol and mechanism applicable in a single WPAN cannot be used. Therefore, additional protocol and mechanism for communication between WPANs are needed.

With reference to FIG. 2, assuming that PAN IDs of the two WPANs are the same, a mobile node “New” detects that the address “33” of two different mobile node conflicts. In this situation, the mobile node “New” cannot normally join the WPAN.

To support communication between WPANs, suppression of additional overhead generation and requirements applied for communication in one WPAN should be taken into consideration. Accordingly, methods for reducing additional overhead in communication between WPANs and for constituting the WPAN capable of applying protocol and mechanism applied to a single WPAN should be addressed.

As mobile nodes constituting a WPAN are comparatively simple devices, a simple method of constituting a WPAN also should be required.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above. An aspect of the present invention is to provide a method of allocating an address based on PAN ID which is a type of variable randomly set so as to constitute a WPAN in a comparatively simple method.

Another aspect of the present invention is to provide a method for detecting an adjacent WPAN in a comparatively simple method. Additionally, yet another aspect of embodiments of the present invention is to provide a method for detecting and resolving PAN ID conflict simply and efficiently when PAN ID conflict occurs between WPANs.

According to another aspect of the present invention, there is provided a method for applying tree routing and route discovery in a single WPAN to communication between WPANs.

According to another aspect of the present invention, there is provided a method of allocating an address to a mobile node constituting a wireless network in a tree structure, the method comprising: the mobile node, receiving wireless network identification (ID);, and setting an address of the mobile node, based on the wireless network ID.

In the setting of the address of the mobile node, the mobile node sets the address of the mobile node by calculation based on an address, which is pre-allocated to the mobile node by its parent node, and the wireless network ID.

In the setting of the address of the mobile node, the mobile node sets the address of the mobile node by adding ‘the product of multiplying the wireless network ID by a predetermined integer’ and ‘the pre-allocated address’ through joining mechanism.

The integer based on the network ID is the maximum number of mobile nodes included in the wireless network.

The network ID is randomly set by a coordinator of the wireless network.

The mobile node may also acquire an address of another mobile node from information received from the other mobile node, and recognize a wireless network ID of a wireless network including the other mobile node, based on the address of the other mobile node.

The method may further provide receiving two types of IDs of the wireless network including the other mobile node, from the mobile node; and determining if the wireless network IDs overlap between ‘a first wireless network including the other mobile node’ and ‘a second wireless network different from the first wireless network’, based on the information transmitted to the coordinator.

The coordinator may transmit the determined result to a coordinator of the first wireless network, if the wireless network IDs are overlapped between the first wireless network and the second wireless network.

The coordinator of the first wireless network may alter the wireless network ID of the first wireless network.

The coordinator of the first wireless network may change the wireless network ID of the first wireless network to a network ID which is not used by other wireless networks.

The mobile nodes constituting the first wireless network may receive the altered first wireless network ID from the coordinator of the first wireless network; and the mobile nodes constituting the first wireless network may reset addresses of the mobile nodes, based on the first wireless network ID.

The mobile nodes constituting the first wireless network may receive the altered first wireless network ID from the coordinator of the first wireless network; and the mobile nodes constituting the first wireless network may update a table relating to preset addresses, based on the first wireless network ID.

There is further provided a method of allocating an address to a mobile node constituting a wireless network in a tree structure, wherein the mobile node sets the address of the mobile node by calculation based on ‘an address, which is pre-allocated to the mobile node’, and ‘an arbitrarily set variable’.

There is further provided a networking method of a mobile node constituting a wireless network in a tree structure comprises: the mobile node, acquiring an address of another mobile node from information received from the other mobile node; and determining a network ID of a network including the other mobile node by calculation based on the address of the other mobile node and a predetermined integer.

The predetermined integer is the maximum number of mobile nodes included in the wireless network.

### BRIEF DESCRIPTION OF THE DRAWINGS

The above and/or other aspects of the present invention will be more apparent by describing certain embodiments of the present invention with reference to the accompanying drawings, in which:

FIG. 1 is a view provided to describe a method of assigning addresses in a WPAN according to the related art;

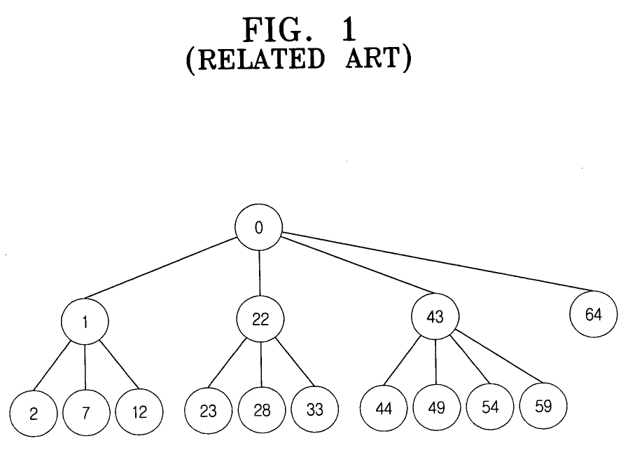

FIG. 2 is a view provided to describe address conflict caused by a plurality of WPANs according to the related art;

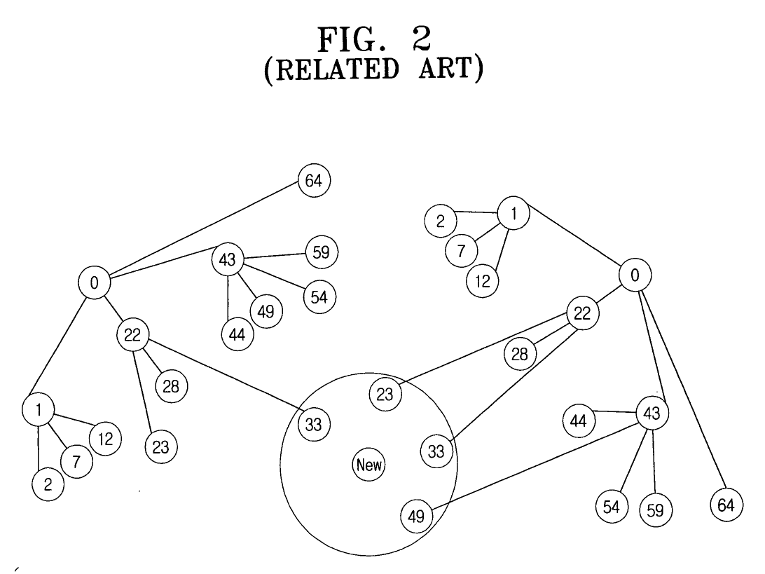

FIG. 3 is a view provided to describe a method of assigning addresses in a WPAN according to an exemplary embodiment of the present invention;

FIG. 4 is a view showing two WPANs assigned addresses according to an exemplary embodiment of the present invention;

FIG. 5 is a view provided to describe a method of detecting a WPAN adjacent to a mobile node;

FIG. 6 is a view provided to describe a process of updating tree route tables of mobile nodes;

FIG. 7 is a view provided to describe a method of transmitting a packet to a detected WPAN, if two mobile nodes detect the adjacent WPAN;

FIG. 8 is a view provided to describe a method of sensing PAN ID conflict of other WPANs adjacent to a WPAN;

FIGS. 9 and 10 are view provided to describe a process of resolving PAN ID conflict of two WPANS; and

FIG. 11 is a view provided to describe a route discovery process of a mobile node.

### DETAILED DESCRIPTION OF EXEMPLARY EMBODIMENTS OF THE INVENTION

Exemplary embodiments of the present invention will be described in greater detail with reference to the accompanying drawings.

In the description of the exemplary embodiments, same drawing reference numerals are used for the same elements even in different drawings. The matters defined in the description such as a detailed construction and elements are provided to assist in a comprehensive understanding of the invention. Thus, it is apparent that the present invention can be carried out without those defined matters. Also, well-known functions or constructions are not described in detail since they would obscure the invention in unnecessary detail.

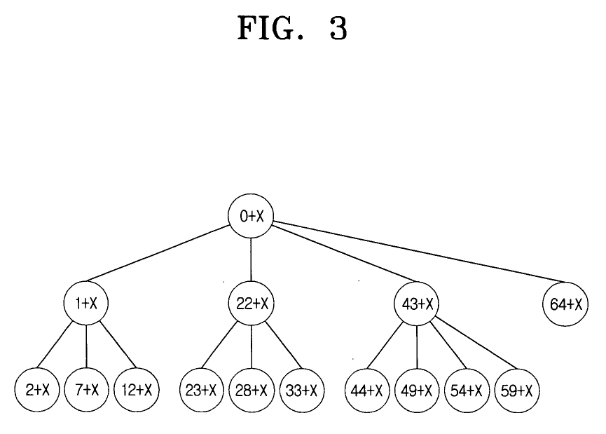

FIG. 3 is a view provided to describe a method of assigning addresses in a WPAN according to an exemplary embodiment of the present invention. The WPAN may have a tree structure.

The method of assigning addresses is based on a PAN ID of a WPAN in order to assign different addresses to nodes belonging to different WPANs, and will be described in detail.

With reference to FIG. 3, mobile nodes constituting the WPAN set as their addresses the sum of ‘addresses pre-assigned to the mobile nodes’ 0, 1, 2, 7, 12, 22, 23, . . . , 64 and ‘address offset’ X.

The pre-assigned addresses may be addresses assigned by a conventional method of assigning addresses.

The ‘address offset’ X may be the product of multiplying a ‘size of the address block’ A by a ‘PAN ID’ (X=A*PAN ID). The ‘size of the address block’ indicates the maximum number of mobile nodes in the WPAN, and is determined by a stack profile ID. All the mobile nodes constituting the WPAN recognize the size of the address block. The size of the address block can be restricted to a preset size if necessary.

The ‘PAN ID’ is randomly set by a coordinator (0+X). The set PAN ID is transmitted to all the mobile nodes constituting the WPAN, so they recognize the PAN ID of their WPAN.

In brief, the mobile nodes constituting the WPAN i) calculate address offsets by multiplying the known ‘size of the address block’ by the ‘PAN ID’, and ii) set their own addresses by adding ‘allocated addresses’ to the calculated ‘address offsets’.

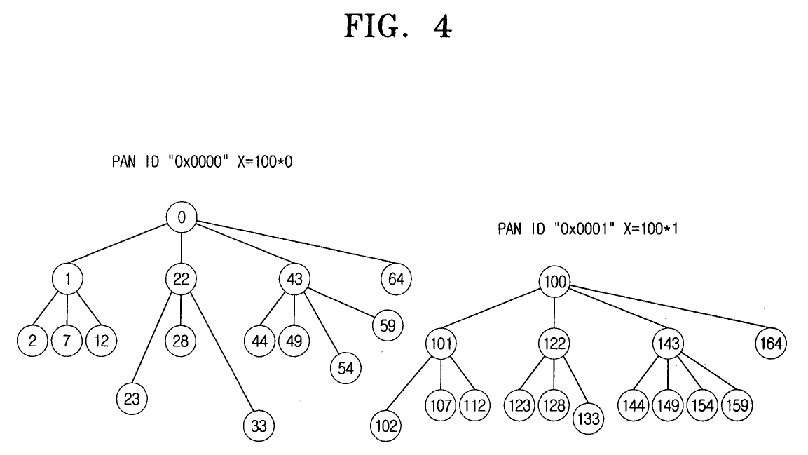

Two adjacent WPANs having addresses of mobile nodes set in the above method are shown in FIG. 4. The size of the address block is set to ‘100’.

As the PAN ID of the WPAN on the left of FIG. 4 is 0(0 X 0000), 0(=100*0) is used as the address offset X to set addresses of mobile nodes in the WPAN. Likewise, as the PAN ID of the WPAN on the right of FIG. 4 is 0(0 X 0001), 100(=100*1) is used as the address offset X to set addresses of mobile nodes in the WPAN.

That is, the mobile nodes shown in FIG. 4 set their own addresses based on the address offset determined based on randomly set PAN ID.

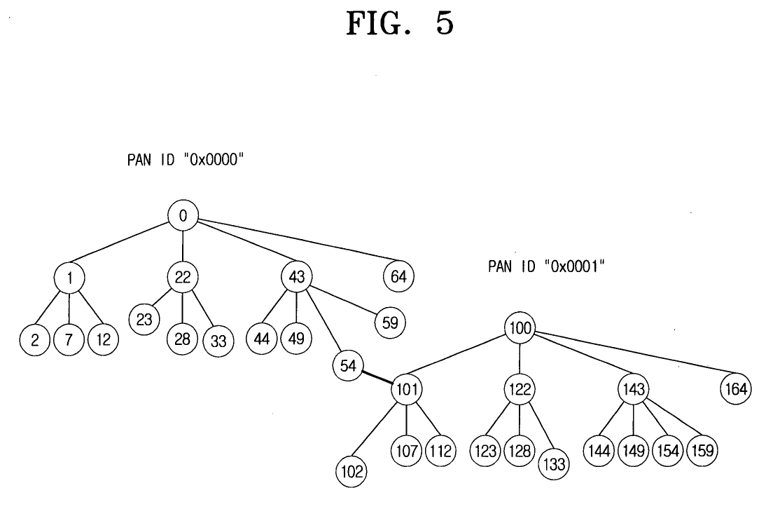

The method of assigning addresses to mobile nodes in the WPAN based on PAN ID which is a type of randomly set variable has been described in detail above. Hereinafter, when addresses have been assigned to mobile nodes in the above method, a method of detecting a WPAN adjacent to a mobile node is described in detail with reference to FIG. 5. FIG. 5 is a drawing showing a method of detecting a WPAN adjacent to a mobile node.

When detecting an adjacent WPAN, a mobile node 54 can use a data packet as well as a beacon transmitted from a mobile node 101 belonging to the adjacent WPAN (0 X 0001).

The process of detecting the adjacent WPAN (0 X 0001) based on a data packet transmitted from a mobile node 101 belonging to the adjacent WPAN (0 X 0001) is as follows.

Firstly, the mobile node 54 extracts an address “101” from the received data packet. The mobile node 54 determines whether the extracted address “101” is included in the address block of the WPAN (0 X 0000) of the mobile node 54.

The address block of WPAN (0 X 0000) of the mobile node 54 is [“X+0”, “X+1”, “X+2”, . . . , “X+A”]. It is mentioned above that ‘X (=A*PAN ID)’ is the address offset and ‘A’ is the size of the address block. In this exemplary embodiment, as the size of the address block A is set to “100” and the PAN ID is 0 (0 X 0000), the address offset X becomes “0”. Accordingly, the address block of the WPAN (0 X 0000) of the mobile node 54 becomes [0(0+0), 1(0+1), 2(0+2), . . . , 100(0+100)].

According to the foregoing description, as the extracted address “101” is not included in [0, 1, 2, . . . , 100], which is the address block of WPAN (0 X 0000) of the mobile node 54, the mobile node 54 recognizes that the WPAN (0 X 0001) of the mobile node 101 is different from the WPAN (0 X 0000) of the mobile node 54. As a result, the mobile node 54 recognizes that there is a WPAN (0 X 0001) adjacent to the mobile node 54.

Meanwhile, the mobile node 54 can calculate the PAN ID of the WPAN (0 X 0001) of the mobile node 101 from the extracted address “101”. Specifically, the mobile node 54 calculates the PAN ID by dividing the extracted address “101” by the size of the address block. As shown in FIG. 5, 1 (0 X 0001) which is the quotient of dividing the extracted address “101” by the size of the address block, is calculated as the PAN ID of the WPAN. As the calculated PAN ID (0 X 0001) is different from the PAN ID (0 X 0000) of the WPAN of the mobile node 54, the mobile node 54 recognizes that there is a WPAN (0 X 0001) in the adjacent area.

After recognizing that there is a WPAN (0 X 0001) in the adjacent area, the mobile node 54 reports the detection results to the coordinator 0. The coordinator 0 recognizes the existence of another WPAN via the report and responds to the mobile node 54.

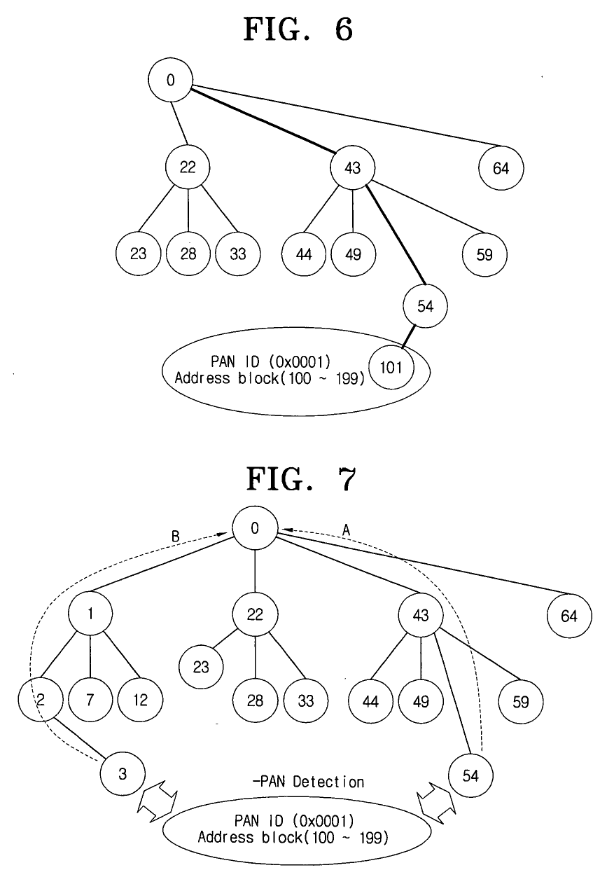

Hereinafter, referring to the detection results of the existence of another WPAN reported from the mobile node 54, a process of updating the tree route tables of the mobile nodes will be described in detail with reference to FIG. 6.

Firstly, a coordinator 0 updates its own tree route table so as to transmit a packet, having a destination address included in the address block 100, 101, . . . , 199 of an adjacent WPAN (00 X 0001), to a mobile node 43.

The mobile node 43 updates its own tree route table so as to transmit the packet, having a destination address included in the address block 100, 101, . . . , 199 of the adjacent WPAN (0 X 0001), to the mobile node 54.

The mobile node 54 updates its own tree route table so as to transmit the packet, having a destination address included in the address block 100, 101, . . . , 199 of the adjacent WPAN (0 X 0001), to the mobile node 101.

When the tree route tables of the coordinator 0 are updated, and the mobile node 43 and the mobile node 54 are updated, all the mobile nodes constituting the WPAN (0 X 0000) can transmit packets to the adjacent WPAN (0 X 0001) via the mobile node 54.

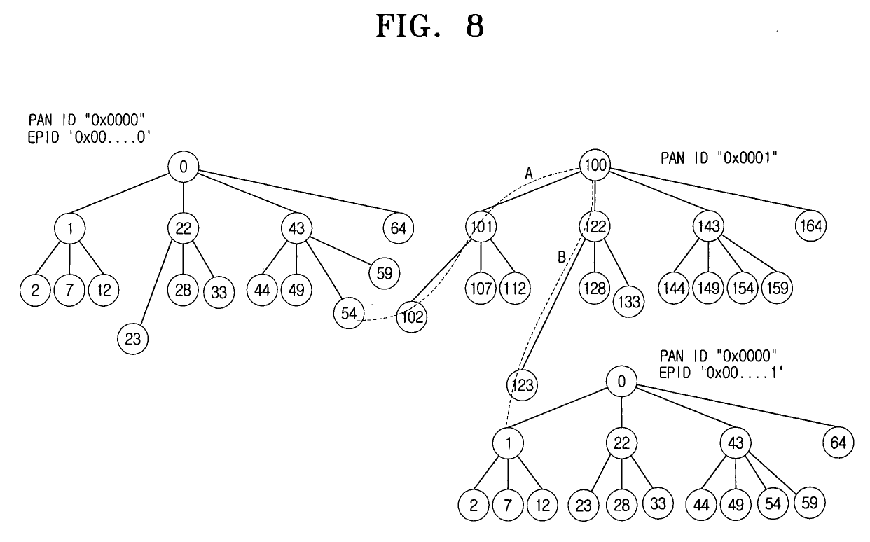

If two mobile nodes, 3 and 54, detect adjacent WPAN (0 X 0001) as shown in FIG. 7, the detection results are reported via two paths.

In this case, mobile nodes 1, 2, 7 and 12 can transmit packets to the adjacent WPAN (0 X 0001) via the mobile node 3. Additionally, mobile nodes 43, 44, 49 and 59 can transmit packets to the adjacent WPAN (0 X 0001) via the mobile node 54.

Meanwhile, according to the situation of the route, the mobile nodes 1, 2, 7 and 12 can also transmit packets to the adjacent WPAN (0 X 0001) via the mobile node 54. Likewise, mobile nodes 43, 44, 49 and 59 can also transmit packets to the adjacent WPAN (0 X 0001) via the mobile node 3.

Mobile nodes 0, 22, 23, 28, 33 and 64 can transmit packets to the adjacent WPAN (0 X 0001) via the mobile node 3 or the mobile node 54.

According to the above-described routing process, when transmitting packets to an adjacent WPAN, it is only necessary that the address of a destination node belonging to the adjacent WPAN is included in the packet. Although the packet does not have the PAN ID of the adjacent WPAN, there is no problem with transmitting the packet.

Even though the PAN IDs of WPANs are set randomly, the PAN IDs of the WPANs might conflict with each other.

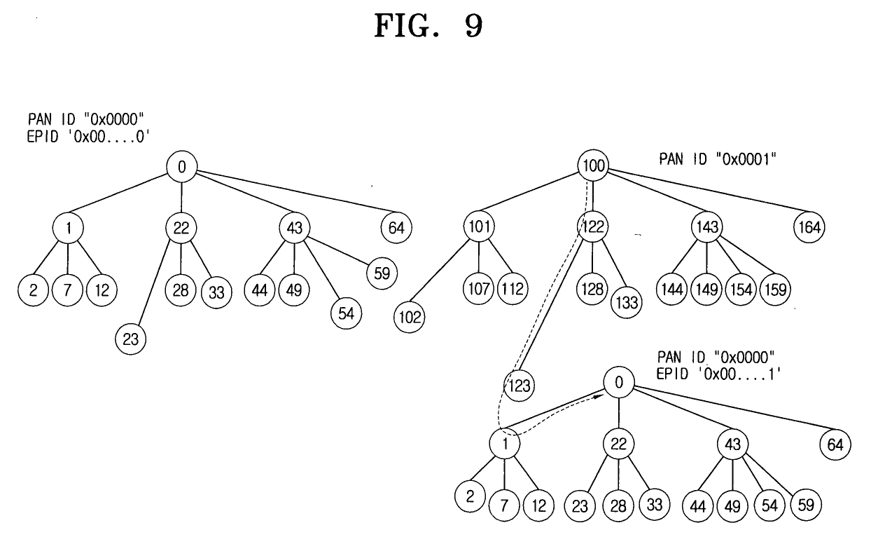

Hereinafter, a method of sensing the PAN ID conflict of WPANs adjacent to a WPAN will be described in detail with reference to FIG. 8.

Among the three WPANs in FIG. 8, the PAN IDs of WPANs on the left and on the lower right are the same 0 X 0000, but the WPANs are not connected to each other, so they cannot sense the PAN ID conflict. However, the WPAN (0 X 0001) on the upper right can sense the PAN ID conflict.

More specifically, a coordinator 100 of WPAN (0 X 0001) receives PAN ID “0 X 0000” and Extended PAN ID (EPID) “0 x 0000000000000000” of the WPAN including a mobile node 54, from the mobile node 54 via path “A”. Additionally, the coordinator 100 of WPAN (0 X 0001) receives PAN ID “0 X 0000”, and Extended PAN ID (EPID) “0 x 0000000000000001” of the WPAN including a mobile node 1 from the mobile node 1 via path “B”.

The coordinator 100 of the WPAN (0 X 0001) on the upper right recognizes that the two received PAN IDs “0 X 0000” and “0 X 0000” are the same, but the two received EPIDs (0 X 00 . . . 0 and 0 X 00 . . . 1) are different, so the coordinator 100 can sense PAN ID conflict of the two WPANs.

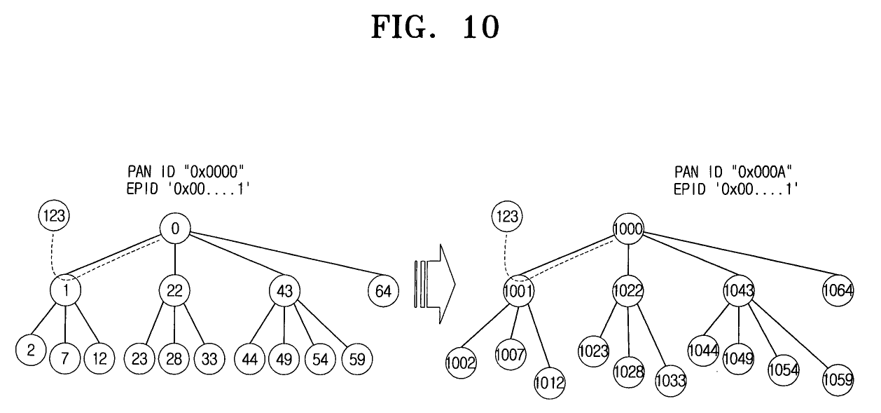

Hereinafter, a process of resolving a PAN ID conflict of two WPANs will be described in detail with reference to FIGS. 9 and 10.

Referring to FIG. 9, the coordinator 100 of WPAN (0 X 0001) on the upper right transmits a PAN ID conflict reporting message to a coordinator 0 of the WPAN (EPID: 0 X 00 . . . 1) on the lower right which has received PAN ID and EPID later among the two adjacent WPANs. The transmission path can be “100→122→123→1→0”. The PAN ID conflict reporting message can be interpreted as a PAN reconfiguration requesting message.

The coordinator 0 of the WPAN (EPID: 0 X 00 . . . 1) on the lower right receives the message, alters the PAN ID, and resets its address based on the altered PAN ID. The altered PAN ID is transmitted to lower nodes, and the lower nodes reset their addresses based on the altered PAN ID.

A method of resetting an address can be implemented in the aforementioned method of setting an address, and detailed description will be omitted.

FIG. 10 shows the results of resetting addresses of mobile nodes based on the altered PAN ID, after the PAN ID of the WPAN (EPID: 0 X 00 . . . 1) on the lower right of FIG. 9 is altered to 10 (0 X 000A). According to FIG. 10, addresses are reset by adding address offset 1000 (100*10) to the preset addresses (0, 1, 2, . . . , 64).

All the mobile nodes constituting the WPAN (EPID: 0 X 00 . . . 1) update addresses on the route table based on the altered PAN ID. More specifically, among the addresses on the route table, addresses of the mobile nodes belonging to the WPAN (EPID: 0 X 00 . . . 1) are added with address offset “1000”. Accordingly, mobile nodes can update the route table with a comparatively simple process.

Mobile nodes constituting another WPAN, not the WPAN (EPID: 0 X 00 . . . 1) updates addresses on the route table based on the altered PAN ID of the WPAN (EPID: 0 X 00 . . . 1). More specifically, among the addresses on the route table, addresses of the mobile nodes belonging to the WPAN (EPID: 0 X 00 . . . 1) are added with an address offset of “1000”. Accordingly, mobile nodes constituting another WPAN can update the route table with a comparatively simple process.

As described above, a route table is exemplified as an updated table. However, any table relating to addresses as well as a neighbor table can be updated according to the foregoing process.

Meanwhile, the PAN reconfiguration requesting message, transmitted from the coordinator 100 of the WPAN (PAN ID: “0 X 0001”) on the upper right of FIG. 9 to the coordinator 0 of the WPAN (EPID: 0 X 00 . . . 1) on the lower right, may include the PAN ID “0 X 0001” of its WPAN. This is because the PAN ID altered by the coordinator 0 of the WPAN (EPID: 0 X 00 . . . 1) on the lower right is prevented from conflicting with PAN ID (“0 X 0001”) on the upper right.

As described above, the PAN ID is altered and address is reset in the WPAN which receives the PAN ID and EPID later, but this is just one example. The PAN ID is altered and the address can be reset in the WPAN which receives the PAN ID and EPID first, or the WPAN can alter the PAN ID and the reset address can be implemented to be decided according to the preset reference.

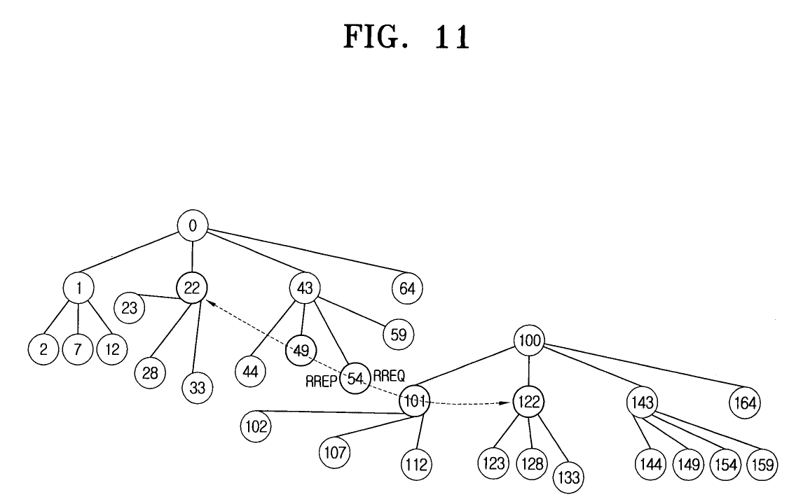

Hereinafter, a route discovery process of a mobile node will be described for when addresses of mobile nodes are allocated according to the above method. FIG. 11 shows that a route request (RREQ) and a route reply (RREP) are transmitted in order to find an optimal path to transmit a packet from a mobile node 22 in the WPAN on the left to a mobile node 122 in the WPAN on the right.

The transmitted RREQ and RREP do not need to include the PAN ID, as including only the address of the mobile node is sufficient. This is because the address of the mobile node is unique among the plurality of WPANs, so that even if the WPAN including the mobile node is not known, there is no problem with transmitting the RREQ and the RREP.

Furthermore, as the PAN ID of the WPAN including a mobile node can be calculated from the address of the mobile node, the PAN ID does not need to be included in the RREQ and the RREP.

As the address of the mobile node is set based on the PAN ID, the PAN ID of the WPAN including the mobile node can be calculated from the address of the mobile node.

As can be appreciated from the above description, an address is set based on the PAN ID which is a kind of a randomly set variable, so addresses of mobile nodes can avoid conflict in a comparatively simple manner.

Additionally, an adjacent WPAN can be detected in a comparatively simple manner, PAN ID conflict between WPANs is detected/resolved, and tree routing and route discovery applied to one WPAN can also be applied to communication between WPANs.

The foregoing exemplary embodiments are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A method of allocating an address to a mobile node constituting a wireless network in a tree structure, the method comprising:
the mobile node, receiving wireless network identification (ID); and
the mobile node, setting an address of the mobile node, based on the wireless network ID.

2. The method of claim 1, wherein in the setting of the address of the mobile node, the mobile node sets the address of the mobile node by calculation based on an address, which is pre-allocated to the mobile node, and the wireless network ID.

3. The method of claim 2, wherein in the setting of the address of the mobile node, the mobile node sets the address of the mobile node by adding a product of multiplying the wireless network ID by a predetermined integer and the pre-allocated address.

4. The method of claim 3, wherein the predetermined integer is a maximum number of mobile nodes included in the wireless network.

5. The method of claim 1, wherein the wireless network ID is randomly set by a coordinator of the wireless network.

6. The method of claim 1, further comprising:
the mobile node, determining an address of another mobile node based on information received from the other mobile node; and
the mobile node, recognizing a wireless network ID of a wireless network including the other mobile node, based on the determined address of the other mobile node.

7. The method of claim 6, further comprising:
a coordinator of the wireless network including the mobile node, receiving from the mobile node two types of IDs of the wireless network including the other mobile node; and
determining if the wireless network IDs overlap between a first wireless network including the other mobile node and a second wireless network different from the first wireless network, based on the information transmitted to the coordinator.

8. The method of claim 7, further comprising:
the coordinator of the wireless network including the mobile node, transmitting the determined overlap result to a coordinator of the first wireless network, if the wireless network IDs are overlapped between the first wireless network and the second wireless network.

9. The method of claim 8, further comprising:
the coordinator of the first wireless network, altering the wireless network ID of the first wireless network.

10. The method of claim 9, wherein the coordinator of the first wireless network alters the wireless network ID of the first wireless network to a network ID which is not used by other wireless networks.

11. The method of claim 10, comprising:
mobile nodes constituting the first wireless network, receiving the altered first wireless network ID from the coordinator of the first wireless network; and
the mobile nodes constituting the first wireless network, resetting addresses of the mobile nodes, based on the first wireless network ID.

12. The method of claim 10, further comprising:
the mobile nodes constituting the first wireless network, receiving the altered first wireless network ID from the coordinator of the first wireless network; and
the mobile nodes constituting the first wireless network, updating a table relating to preset addresses, based on the first wireless network ID.

13. A method of allocating an address to a mobile node constituting a wireless network in a tree structure, wherein the mobile node sets the address of the mobile node by calculation based on an address, which is pre-allocated to the mobile node, and an arbitrarily set variable.

14. A networking method of a mobile node constituting a wireless network in a tree structure, the method comprising:
the mobile node, acquiring an address of another mobile node from information received from the other mobile node; and
determining a network ID of a network including the other mobile node by calculation using the address of the other mobile node and a predetermined integer.

15. The method of claim 14, wherein the predetermined integer is a maximum number of mobile nodes included in the wireless network.
